(19) United States
(12) Patent Application Publication
(10) Pub. No.: US 2006/0265397 A1
(43) Pub. Date: Nov. 23, 2006

(54) Methods, systems, and computer program products for extensible, profile-and context-based information correlation, routing and distribution

(75) Inventors: Edward L. Bryan, Durham, NC (US); David T. Bennett, Chapel Hill, NC (US); Richard W. Zobel JR., Raleigh, NC (US); Donald J. Bell, Chapel Hill, NC (US); Laura C. Vandivier, Durham, NC (US); Jason K. Pace, Raleigh, NC (US); Robert L. Welton, Clayton, NC (US); Willem J. A. Pet, Durham, NC (US)

Correspondence Address: JENKINS, WILSON, TAYLOR & HUNT, P. A., 3100 TOWER BLVD, SUITE 1200, DURHAM, NC, 27707, US

(73) Assignee: Knowledge Vector, Inc.

(21) Appl. No.: 11/359,888

(22) Filed: Feb. 22, 2006

Related U.S. Application Data
(63) Continuation-in-part of application No. 10/020,260, filed on Dec. 14, 2001.
Application No. 10/020,260 is a continuation-in-part of application No. 09/800,371, filed on Mar. 6, 2001, now Pat. No. 6,658,414.
(60) Provisional application No. 60/655,152, filed on Feb. 22, 2005.

(51) Int. Cl. G06F 17/30

(52) U.S. Cl. 707/10

(57) ABSTRACT

Methods, systems, and computer program products for extensible, profile- and context-based information correlation, routing, and distribution are disclosed. According to one system, source plug-ins receive output from a plurality of different sensors. A content manager merges data from individual sensors together with metadata that is representative of a context and aggregates the sensor data and the context metadata into knowledge items. A scenario engine achieves sensor fusion by comparing the sensor data and its context metadata against a defined set of policies and/or rules and provides for performance of an action when a rule or policy is satisfied.

### RELATED APPLICATIONS

This application is a continuation-in-part of U.S. patent application Ser. No. 10/020,260, filed Dec. 14, 2001, which is a continuation-in-part of U.S. patent application Ser. No. 09/800,371, filed Mar. 6, 2001 (now U.S. Pat. No. 6,658,414), and this application further claims the benefit of U.S. Provisional Patent Application No. 60/655,152, filed Feb. 22, 2005, the disclosures of each of which are hereby incorporated herein in their entireties.

### TECHNICAL FIELD

The subject matter described herein relates generally to the fusion and communication of field collected event data. More particularly, the subject matter described herein relates to methods, systems, and computer program products for extensible, profile- and context-based information correlation, routing, and distribution. Even more particularly, the subject matter described herein relates to an extensible software architecture for allowing individuals, groups, and organizations to contextually gather, correlate, distribute, and access information, both manually and automatically, over a multiplicity of communication pathways to a multiplicity of end user communication devices.

### BACKGROUND ART

With the overwhelming proliferation of sensors in the world today, there is a demand for systems that operate at a layer above these sensors and that have the capability to take the filtered (or even raw) output from these sensors, understand the output within a real-world context, compare the data and context against a defined set of policies and/or rules, then quickly and precisely get this fused information into the hands of those that need to be aware of it.

As used herein, a “sensor” refers to any of a wide number of systems, devices, software, or live observers that are able to capture and transmit data regarding one or more characteristics of the environment, software, database or system that they have been tasked with monitoring. A sensor may include any mechanical, electro-mechanical, or electronic device capable of producing output based on observed or detected input. As used herein, “rules” are algorithmic constructs that are used for the analysis or comparison of variables (typically received from sensors). As used herein, “policies” are organizationally defined procedures or rules, typically found as standard operating procedures logged in operations manuals, experience captured from subject matter experts, or experience captured from operations personnel. As used herein, “sensor fusion” refers to the real-time process of aggregating data from disparate sensors, applying one or more layers of policies/rules to sort out the important events from the background noise, and the subsequent creation of context-rich alerts when the rules are satisfied.

It is no longer a surprise to discover that at any particular time and in nearly any public environment that a person's picture may be being taken, that a person's frequent-shopper ID is being requested and recorded, that a person's movements are automatically triggering sensors to turn on lights or open doors or issue personalized vouchers, that a person's personal identification must be used as a required key for entry, that a guard enters the person's name and license number as they enter a protected community, that a person's credit card must be swiped to initiate or conclude a transaction, or that any of a multiplicity of other facts, data points or alerts are almost continually requested, collected and recorded as an artifact of a person's presence or participation within nearly any public environment. This data collection from an array of sensors is, of course, even more prevalent in environments that are specifically designed to be secure and thereby designed to know very precisely who and what is allowed to pass and who must be kept out, such as with automated sensor systems for perimeter, border or facility security.

One problem with the proliferation of sensors, both in secure and non-secure uses, is a lack of sensor fusion. The sensors operate, alarm, and communicate their individual alarms independently from one another. The only point where all of the sensors are looked at as a unified system is in the control room or “war room” where a handful of trained observers are tasked to visually and/or audibly monitor the alerts from the termination points of each of the individual systems. These human observers become the manual fusion system by watching for the alarms being issued by each separate system and are trained to recognize the cross-system patterns of alarms that would suggest that there is something noteworthy of interest happening within the range of the sensors. These observers are tasked not only with maintaining a visual, aural, and mental alertness for hours on end, but also with being experts in the interpretation of the stream of alerts being issued by each of the systems and understanding when the combined pattern from multiple systems is more than just “typical” noise and consequently that some action should be undertaken. This use example is true not only for facility security, but also for manufacturing lines, network operations centers, transportation hubs, shipping ports, event security, operations centers, and any place where more than one type of sensor is deployed with the intent to assist, augment or improve upon a limited number of field-deployed human observers.

Furthermore, when these human observers who are tasked with the responsibility of being the point of fusion do determine that something of interest or concern is occurring, they must then consult an additional policy manual and/or directory to find some means to concisely communicate this information to the appropriate individual(s) via some appropriate communications path (phone, email, pager, radio, fax, etc). This task is not always straightforward since the individual(s) best suited to receive this information may be unavailable or unreachable via their primary communication method. Furthermore, it may be important to get the information quickly transmitted to more than one individual, each with their own particular need for specific components of the fused information.

The need for sensor fusion systems can be thought of as being directly analogous to the need for the trained observers who sit in front of the tens or hundreds of video screens watching the alarms and video surveillance systems as they are individually issuing alerts, then making an informed decision about the particular groupings and/or timings of the alarms as being important, based on their knowledge of policy and experience, and then determining the appropriate means for communicating this information to the people who need it.

However, while the solution of having highly trained observers has worked reasonably in the past, as more and more sensors of increasing complexity become available and are installed, the ability for even a team of human observers to make sense of the aggregate sum becomes impossible. Additionally, the policy manuals which dictate the nature of how the aggregate is interpreted change more and more frequently with the introduction of the new sensors, and finally, so do the contact policies and individual's contact information. Making sense of the plethora of data emitting from even a typical installation is quickly becoming unmanageable. This inability to manage and interpret the sensor data is leading to a significantly lowered situational awareness and an inability to react to events that are critical.

Accordingly, there exists a quickly growing need for methods and systems that are able to examine a wide variety of information based on defined rules for sensor fusion and which enable the distribution of this information and its relevant context to individual users and other systems in an automated fashion based on their personal contact profiles.

### SUMMARY

According to one aspect, the subject matter described herein includes a system for merging data from a plurality of different sensors and for achieving sensor fusion based on a rule or policy being satisfied. The system includes a plurality of source plug-ins for receiving data from a plurality of different sensors. A content manager merges the data from the sensors together with metadata that is representative of a context and aggregates the information and context metadata into knowledge items. A scenario engine achieves sensor fusion by comparing the sensor data and its context metadata against a predefined set of policies or rules and for providing an action when a rule or policy is satisfied.

The subject matter described herein includes a system that includes the capability to define and utilize scenario-based rule and policy definitions in order to correlate event-based data across a multitude of sensor systems to determine, in real time, if the criteria for the specified policy(ies) have been successfully satisfied. This capability will be referred to herein as sensor fusion, and the system which incorporates this capability will be referred to herein as a knowledge switch (KSX). Additionally, the present subject matter includes a system for providing the capability to record a specified accumulation of data and the current context (metadata) at the point that the rule/policy is satisfied and for encapsulating this set of disparate data into a self-encapsulated, decomposable data object. The bundle of fused data, along with its metadata context and history will be referred to herein as a knowledge item.

Moreover, the subject matter described herein includes methods for initiating predefined sequences of events when the rule(s)/policy(ies) become valid, which can include the pinpoint distribution of the data object, starting an application, triggering an alarm or handing off the data to another set of rules/policies. Additionally, the subject matter described herein includes the routing of the knowledge item (with additional pre-defined message information, if desired) to people or systems that need to be made aware of this information, based on the recipient's personal profile, as well as both static and dynamic organizational-based delivery rules. This includes the ability to transmit the data object to a second knowledge switch to allow for two-way switch-to-switch communication. Furthermore, the system-based software architecture of the subject matter described herein can be dynamically extended, with its functionalities and capabilities enhanced through the addition of external software modules which are plugged in to the base framework of the application.

Sensor Fusion

Accordingly, it is an object of the subject matter described herein to provide methods and systems for correlating diverse, event-based data across a multiplicity of sensor systems, based on scenario-type rules and policy definitions. The event data collected can be of any type (such as any of the types described in the above-referenced priority applications) and as a part of the rules/policies can be compared directly to other data (for example: “If the value of input flow is greater or lesser than output flow by more than 2% . . . ”), can be compared in parallel with other data (for example: “If the external temperature is lower than 50, and the internal temperature is lower than 70, and the external vents are reading as being open, then . . . ”), or can be evaluated on its own (for example: “If the poisonous gas sensor reads as TRUE, then . . . ”).

Data Object (Knowledge Item)

It is another object of the subject matter described herein to provide a method to encapsulate received event data, its history, and its metadata context in response to a rule or policy being triggered and encapsulate the data into a self-defined module. For a simple example, rather than just recording the integer data 86 output from a sensor, the context is included and shipped with metadata indicating that the data is a thermostat reading, taken at 3:02 am, on sensor number 1a2b3c-4, in facility XYZ, in building ABC, has triggered 14 times in the past 7 hours, and is important because it triggered a scenario that was put in place to monitor the temperature inside a mission critical machine room and trigger if any computers in the room are operational and the thermometer is reading at or above 70. The data object that this information is accumulated into is decomposable such that an individual data element can be quickly recovered upon request. This data object is referred to herein as a knowledge item.

A knowledge item may include a dollop of content that has actions and whose values over time are preserved, further, a knowledge item may:
Maintain a common metadata format to allow direct comparisons of any kind of data regardless of source or type
Maintain source and history
Have a type that has an associated definition library
Allow definitions and data to be passed to other systems to allow appropriate context within a distributed network of knowledge switches
Allow data within system to be used for both scenarios and topics
Allow for logical, hierarchical access to all data when populating scenarios and topics
Have a Type (Class)
   Version
   Owner (knowledge switch that created the knowledge item and holds the “official” library/definition)
Allow aggregation of data attributes, objects and/or other knowledge items
   Hierarchical with inheritance
   Individually addressable (instance level attributes and access control)
      Name
      Description
      Type
      Access Control
   Be decomposable
Include actions which can be executed upon that knowledge item
Include history/log and timestamp of all actions that have been performed on this knowledge item over its lifetime for analysis and message loop detection
   Message Routing and Filtering

It is yet another object of the subject matter described herein to provide methods and systems for highly granular, automated routing of the data and its context to people and other machines based not only on the recipient's profile, but also on organizational rules, security rules, no-response rules, and next-in-line rules. This methodology allows individuals and systems to be delivered information in a precise way so that not only is the best contact method used, but the message can also be filtered to suit the specific expectations of the recipient, as well as having security measures put in place (authorization methods to prove you are who the system believes you to be and access restrictions to ensure that no information reaches the recipient that they are not allowed to see). Additionally, information within the profile can define logical next-tier recipients for both personal and organizational messages if the message still cannot be delivered after all possible routes have been exhausted. This methodology also allows for the transmission of queries and/or questions (multi-choice or open-ended) to individuals or systems to respond to and in turn directly influence a next tier of questions or provide important information to be subsequently transmitted out to other individuals or systems.

This methodology involves a complex series of filtering and qualifying of the content, the recipient, and the device that may happen prior to a message being presented to recipient. The combination of all of these filters existing within a single system and using these filters to qualify the delivery of a message to an appropriate recipient is believed to be advantageous. Exemplary qualifiers that may be used as follows:
1. Authentication [Prove or confirm a users identity] Methodology for confirming a user's identity. Typically this requires both an organizationally approved and maintained unique identifier and a subsequent user-specific and user-maintained pass-code.
2. Acknowledgment [Confirmation that a message was received] Methodology for a recipient to explicitly confirm that the recipient received a message.
3. Certification [Organizational request for a message receipt] An organization-based request for explicit recipient acknowledgment that a message has been received by the recipient prior to being logged as a successful delivery. (As opposed to simply defining success as the successful transmission of a message.)
4. Device Escalation [Progression from device to device to contact a user] Delivery of a message to each of a recipient's devices in stepwise order upon failure to reach the previous device. This is performed according to that recipient's profile preferences and stops escalating when a successful delivery is made. Success may be defined by a minimum of an acknowledged voice delivery or a non-error return on an email or pager.
5. Personal Escalation [Personal backup recipient for delivery] The escalation of a recipient's message to another user profile upon the failure to reach the recipient at any of the recipient's specified contacts. This backup contact can be overridden by an organizationally based escalation user which would be specified in the message's certification definition.
6. Organizational Escalation [Organizational backup user or system] Organization-based request for escalation of a message to another profile which supersedes the user's personal and/or device escalation definitions in their profile.
7. Contact List [List of all means for contacting a user] The contact list is a master list of all of the user's possible contact modalities and acts as a users default profile. From this master list can be drawn subsets of modalities called contact profiles.
8. Contact Profile [Organized sublist for contacting a user] A subset of a user's contact list that can be utilized at different times or for different needs. For example a nighttime profile may only have an email or pager contact, while an office profile may have office phone, cell phone, pager, email, etc. Additionally a contact profile can be defined to capture certain types of messages, (for example a daily corporate message of the day) and take that straight to email rather than have it contact you by phone.

Another example would be an override profile for an urgent alarm priority message that would attempt authenticated contact by phone or pager no matter the time of the day or night.
9. Delivery Preferences [User definition for how the user's profile is utilized] The user-based definition of how contact profiles are utilized by the delivery engine to have a message delivered. The preference is established as a default, but can be overridden by a higher priority organizational delivery preference. Delivery preference examples may be:
   1. Transmission of a message to all of a user's devices in the user's contact list in parallel
   2. Transmission with escalation with authentication
   3. Transmission only to one each of two defaults (for example phone and email).
10. Message Priority [Data tied to a message for sorting for prioritized delivery] An organizationally defined prioritization of a message that effects placement in the delivery queue, as well as in the recipient's topic box.
11. Authorization Level (content access) [Authorization level for access rights] An organizationally defined, controlled and maintained content access profile. Authorization Level is administratively managed, but may be viewed (but not modified) by the user. For example, in governmental applications the authorization level may be “Secret,” “Top Secret,” or “Compartmentalized,” while in a business, the authorization level may be rated in parallel with a role, like officer, vice president, senior employee, junior employee. Authorization level may be specific to content access.
12. Access Profile (system resource access) [authorization for system resources] An organizationally approved and maintained set of system resources and the individuals that are allowed access to each of these resources. Also known as an ACL (Access Control List) [Pronounced “ackle”].
   Asynchronous Message Routing

It is yet another object of the subject matter described herein to provide methods for the asynchronous routing of messages and data through notification and authentication. For example, it is possible to send a message via pager and within a timeframe, have that person contact the delivery system, authenticate himself, and have the information delivered as though the system had contacted the person directly. This methodology allows for time-independent contact. Current telephone call delivery methods require only that a call to be picked up and answered in order for an acknowledgement of receipt to be assumed. This current methodology can fail if the person picking up the call is not the intended recipient (for example, a child picks up), it can fail if voice mail picks up, and it leaves no options if the intended recipient is busy, or cannot be beside a phone. With the present subject matter, a message can be transmitted (simultaneously if desired) to a pager, email, or a message left on voice mail that defines a range of time for the recipient to respond before the recipient recorded as having not acknowledged the message. In addition to this, a pass-code system can be placed as a front gate (so to speak) that would allow the option of verified access, including access to secure information when the recipient contacts the system. Without this option, all that is known by the transmission system is that the receipt of the transmission was initiated by someone/something. Finally, the same methods can be used at the close of the transmission to verify not only that the transmission was sent, but also that the same person who initiated the transmission completed the transmission and verifies that the person received and understood the transmission.

Dynamic, Rule-Based Group Membership Filtering

It is yet another object of the subject matter described herein to provide methods for dynamic groups where the active members of the overall group are determined only at the time that the request is made. U.S. Pat. No. 6,658,414 discloses in detail a method referred to as microbroadcasting. This method includes the ability to request GPS-based location data as a part of the process of logging in to a user's personal microbroadcast. As an extension the methods disclosed in the '414 patent, the subject matter described herein includes a knowledge switch that can continuously collect this user-profile-specific data such that these fields can be dynamic rather than static. This dynamic data (such as location, time, schedule, duty roster, access control ID) can be utilized within rules (see Roles and Advanced Scenario Logic above) to make moment-by-moment assessments of a rule. This dynamic data can be utilized along with other dynamic data or static data to provide topics of relevance (local forecast or emergency weather alerts for wherever a person is located at that specific time, even if the recipient is driving), access control for physical and content access, roles (as described above), KSX to KSX communications (as described above), and any other mechanism that utilized dynamic input as a factor within a rule to determine the appropriateness of an action or capability.

An example of the subject matter described herein could be the use of the dynamic profile data of duty roster, access control, location, and time to make an assessment about a specific user's ability to have the appropriate privileges as dictated by the role of “Tower Chief”. By defining a rule that includes all of these variables (in English: Give UserX appropriate systems access and authorization to perform as Tower Chief if and only if the following is true: 1) User is geographically within fifty feet of the center of the tower; 2) User has used the appropriate credentials to gain access to the tower floor; 3) User is scheduled within the duty roster to perform this role; and 4) the time is currently between the start and end time on the duty roster that this user is scheduled to perform this role. A dynamic group however does not have to be used exclusively for people; it is limited only by objects that can be grouped and the rules available to filter the group at the time it is requested.

Extensions to Rule and Policy Development

It is yet another object of the subject matter described herein to provide methods for enabling the provision of precise and flexible evaluation criteria for rules and policy definitions within a knowledge switch. The concept of a logic engine that is able to take a logical statement with one or more data points and return a true/false response is described in the above-referenced U.S. patent application Ser. No. 10/020,260, filed Dec. 14, 2001. Additional capabilities of such a logic engine may include:
Ability to utilize mathematical functional expressions as a means for describing the logic being utilized in the statement, whereby the extension of the capabilities of the logic engine are in the run-time creation of a new function rather than the hard-recoding of a task specific parser or evaluation engine.
Utilization of temporal-based functions (X happens five times within a period of 28 hours) through the utilization of historical data (see discussion of knowledge item above), as well as looking time stamp forward, or a combination of historical, current, and forward-looking data evaluation.
Use of inference engines to do trend-analysis-based estimation rather than purely the explicit parsing and evaluation of a logical statement.
Use of the specific context of the data in addition to, or in placement of the received data value from the content source (see discussion of knowledge item above for a description of context).
Use of these logical statements within other components of the knowledge switch for purposes of defining rules to determine specific operating characteristics of that component of the KSX. This includes such tasks as defining the participants of a role, where a role is a group whose member or members are dynamically defined. Defining the contact priorities within a profile, defining content for a topic (See U.S. Pat. No. 6,658,414 for the definition of topic), and for making administrative level decisions about the modification of the operational performance and loading characteristics within the KSX.
Use of dynamic profile data in addition to system-based dynamic and static data, as elements within a rule to make moment by moment decisions about the applicability of some action, the specific content to be provided within a topic, or making decisions about document or physical access control.
Ability for rules to reference data queries and any function (e.g., statistical functions that do not return on a single data value but rather return information about a set of data elements.)
   Extensions to Switch Deployment

It is yet another object of the subject matter described herein to provide methods for two-way communications between two or more individual knowledge switch. As described in U.S. patent application Ser. No. 10/020,260, the ability for a knowledge switch to communicate with another knowledge switch via the transmission of alerts to a series of predetermined templates has significant benefits for the scaling of systems. In addition to such capabilities, the present subject matter may include a facility for allowing administrative-based changes to a knowledge switch's provisioning (content, logic, distribution, profiles) based on a hierarchical relationship. Additionally, methods of making information available based on “need-to-know” rights management within a peer-to-peer relationship are provided. Geographical proximity may also be used as a deterministic factor in the proactive dissemination of information between knowledge switches.

With a hierarchical relationship utilized for KSX-to-KSX communications, some amount of administrative rights are assigned for a parent KSX to proactively and securely provision a child KSX with new logic, new scenarios, new content, new profiles or new rules for the dissemination of information. This ability to do administrative level provisioning allows a parent KSX to define and control the flow of information across a large umbrella of distributed systems. All communications can be managed through a secure web services layer, and administrative rights can be managed locally for each domain. A top down approach can be used for the hierarchical distribution of information and control logic. This methodology minimizes the direct management that a parent needs to maintain for a child node and allows for a true distributed awareness system with localized, domain specific implementation that allows for a large overall umbrella of awareness for the parent KSX. An example of a hierarchical topology would be the Federal Aviation Administration (FAA) knowledge switch as the top parent node, FAA airport regional coordinator knowledge switches as the next tier in the hierarchy, individual airport knowledge switches as the subsequent tier, and other knowledge switches at individual airports as the lowest tier. For example, at the larger airports, individual divisions (such as security, tower, airline, and so forth) may have each have its own KSX for each respective domain. Each KSX may have some administrative oversight by the next logical tier up to allow for discovery and transmission of specific data that may or may not be being scanned for by the local KSX.

The peer-to-peer deployment method presumes a flat topology where all KSX nodes maintain domain-specific knowledge, and there are no administrative rights given to KSX systems to modify another system's provisioning. However, rather than administratively dictated communications flow as exists in a hierarchical topology, a peer-to-peer deployment allows communications via subscription and/or need-to-know messaging. Here the operators of each deployment make determinations of what information to publish and make available to other KSX systems. In a peer-to-peer deployment, information may be passed by request rather than by command. An example of this deployment could be all local police stations sharing information about gang-related crime in their respective regions so that similarities or transient gangs can be more quickly spotted and isolated.

Finally, a geographic-proximity-activated KSX-to-KSX communications methodology allows for domain specific deployment where the sphere of awareness extends to an approximation of a volumetric boundary around the KSX. These spheres of awareness can be located upon a mobile platform (car, train, ship, plane) and can intersect with other spheres of awareness that are also mobile or even perhaps stationary (tunnel, depot, emergency, services). When the intersection of these spheres of awareness is established, the communication of vital information is initiated between the two systems in a directed, peer-to-peer fashion. An example of this type of deployment could be a train carrying dangerous toxins moving between stations and various emergency districts. The train, once it crosses into a new jurisdiction (sphere of awareness based on an emergency services geographical boundary), could pass basic information about cargo types, wheel reports, and emergency information in case of an accident. Information passed into the train could include emergency services contact information for that jurisdiction as it passes through, delays or safety bulletins, and proximity to other known obstacles such as other trains in the area, or traffic tie-ups that could potentially affect an upcoming train crossing.

System Extensibility with Local Provisioning

It is yet another object of the subject matter described herein to provide an overall software architecture that is extensible through the addition of external software modules that are added into the base framework of the application to modify, extend, or add functionality to the base set of functionalities across all major functional modules in the application. The use of a plug-in to extend the standard core architecture has significant merit over the current methods utilized for developing large, enterprise- or facility-wide unifying architectures. Current methods derive solutions through the purpose-developed solution that is largely customized and non-reusable in nature. In all large deployments into existing sites, there is always a great deal of existing legacy equipment, infrastructure, or systems that must be integrated and utilized, or else replaced with new equipment, and then the new equipment or infrastructure or systems must be integrated. This is a time-intensive and expensive method to create a solution and frequently leads to unmaintainable and failure prone systems that require large staffs of administrative and support teams to support. This method of integration and deployment also requires the starting and stopping of a system to add new customized or purpose-built software and/or hardware and begin utilizing the newly added resource. Finally, these systems typically become overly burdened with unused software as the older systems are taken off line and replaced with newer systems that require yet more additional code to be created.

By utilizing a central core to the system that can be used as a standard for knowledge switch deployments and then extending this core through specific and reusable plug-ins that enable the use of the existing infrastructure and existing sensors and legacy systems, the KSX minimizes all of the above risks of a purpose-built solution. A plug-in in this instance is a piece of software that is adapted (or removed) to the core system during run-time (to avoid starting and stopping the system when operating) that allows the externalized systems (sensors, content provider, content rendering definitions, logic engines, external databases of users, delivery systems and devices) to be added (or removed) in to an operating system and begin the immediate utilization of that resource without affecting the remainder of the systems operations. These plug-ins are created to act as intermediaries between the existing deployed systems and the core of the KSX so that the core system does not have to be modified or even stopped in order to extend the capabilities of the overall system.

An example of this could be a KSX deployed as a perimeter security system at a secure facility. A newly developed motion and object detection system has just arrived at the facility along with a new radio communications device. Each of these newly arrived systems has a respective piece of software (plug-in) that was developed by the company to allow their equipment to be utilized as a component of a deployed KSX. The systems are set up and tested separately from the KSX until all the installation bugs are worked out, and the system is ready to be integrated into the operation of the currently operational KSX. The KSX administrator loads the plug-ins from an administrative interface (while the KSX continues to maintain a security watch on the perimeter of the facility), and through the options provided via the plug-in, establishes the way that the subsystem will communicate with the KSX and how the data can be accessed when the provisioning of these new subsystems begins. Once the options are completed by the administrator, the plug-in is activated, and data begins to be transferred between the KSX and the subsystems. Following activation, operations experts can provision the KSX with scenarios that utilize this data from the new systems and cross link it when desirable with the data that was previously in the system.

The use of a plug-in architecture allows the overall deployment configuration to be maintained and optimized over time by:
allowing run-time modifications of what systems are utilized by the KSX,
providing specific (yet changeable) definitions of how systems are utilized within the KSX,
allowing legacy systems to be utilized or decommissioned easily without modifying code,
precise (and changeable over time) definition of how many systems are needed and thus how large the system needs to be to manage these subsystems,
simple scaling of the system through the addition or subtraction of plug-ins,
cost effective deployment,
administrative efficiency for deployment,
ability for a deployment to change dramatically over time with no adverse impact,
ability to control subsystems input on a one-by-one basis, and
ability to refine the storing and navigation of a subsystems data for operational use.

The knowledge switch utilizes a hot-pluggable and swappable plug-in model that allows for the extensibility of functionality for a KSX during run-time with no need to restart any part of the system. A plug-in is a stand-alone, reusable, extensible, language and platform independent piece of software that is written to adapt any external network available data stream to a fixed, published knowledge switch application programming interface (API) layer which is available for extensible modules within the knowledge switch (content manager, scenario engine, profiles manager, message engine and delivery engine). Plug-ins are write once and reuse over and over, such that once a custom plug-in is created to interface an external system's data stream to the knowledge switch, it is not necessary to create any code to interface this same system to another KSX. The plug-in can be re-used with another knowledge switch. The API layer is the handshake point for all data entering and leaving the KSX and thus allows for a highly customized, site-specific configuration without the need to customize the core system. A plug-in can be created as a generic interface to the KSX such that it conforms to a known data transfer standard, such as a web services standard, XML, SNMP, or other recognized standard. Plug-ins can also be created to interface non-standard data streams from systems, and thus the high levels of flexibility and adaptability that plug-ins afford the KSX can be achieved.

The subject matter described herein may be implemented using a computer program product comprising computer-executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer program product that implements the subject matter described herein may be located on a single device or computing platform or may be distributed across multiple devices or computing platforms.

Objects of the present subject matter having been stated hereinabove, other objects will become evident as the description proceeds when taken in connection with the accompanying drawings as best described hereinbelow.

### BRIEF DESCRIPTION OF THE DRAWINGS

Preferred embodiments of the present subject matter will now be explained with reference to the accompanying drawings, of which:

FIG. 1 is block diagram illustrating a simplified exemplary architecture of a knowledge switch showing only the core modules that typically comprise a system according to an embodiment of the subject matter described herein;

FIG. 2 is a block diagram illustrating the knowledge switch of FIG. 1 where additional detail is provided regarding sensor data format and data transport external and internal to the system according to an embodiment of the subject matter described herein;

FIG. 3 is a block diagram illustrating an exemplary deployment of a knowledge switch, where the deployment includes an exemplary infrastructure, exemplary sensors, exemplary message delivery methods, exemplary rules, and exemplary plug-ins for the system according to an embodiment of the subject matter described herein;

FIG. 4 is a block diagram of the knowledge switch of FIG. 3 highlighting details of extensible knowledge switch plug-ins according to an embodiment of the subject matter described herein;

FIG. 5 is a block diagram of the knowledge switch of FIG. 3 highlighting details of the knowledge switch core, the core plus the plug-ins, and external systems with which the knowledge switch may interface according to an embodiment of the subject matter described herein;

FIG. 6 is a block diagram illustrating an exemplary peer-to-peer deployment of knowledge switches according to an embodiment of the subject matter described herein;

FIG. 7 is a block diagram illustrating an exemplary hierarchical deployment of knowledge switches according to an embodiment of the subject matter described herein;

FIG. 8 is a block diagram illustrating an exemplary deployment of knowledge switches on mobile and stationary platforms according to an embodiment of the subject matter described herein; and

FIG. 9 is a flow chart illustrating exemplary overall steps for knowledge item creation and sensor fusion according to an embodiment of the subject matter described herein.

### DETAILED DESCRIPTION OF THE INVENTION

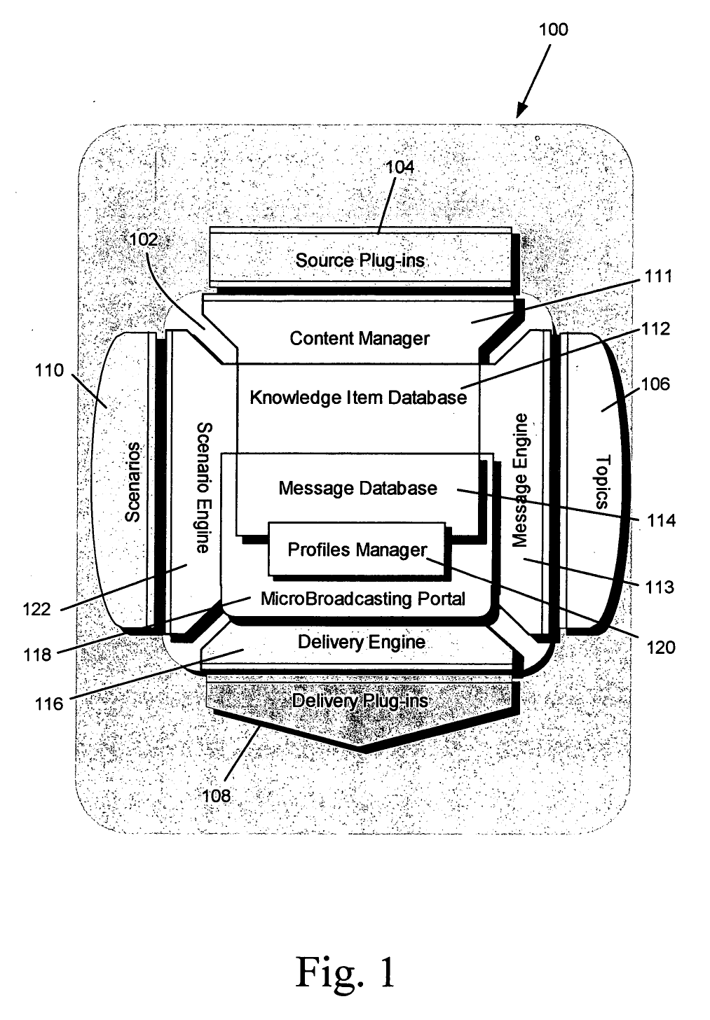

FIG. 1 is a block diagram illustrating exemplary software modules of an extensible system for profile- and context-based information correlation, routing, and distribution according to an embodiment of the subject matter herein. Referring to FIG. 1, the system comprise a knowledge switch 100 including a core 102 and plug-ins 104, 106, 108, and 110 that extend the functionality of core 102. In the illustrated example, core 102 includes software modules that provide basic knowledge switch functionality. Software modules that provide this core functionality included a content manager 111, a knowledge item database 112, a message engine 113, a message database 114, a delivery engine 116, a microbroadcasting portal 118, a profiles manger 120, and a scenario engine 122. Content manager 111 merges data from individual sensors together with metadata that is representative of a real world context and stores the merged data as knowledge items in knowledge item database 112. Knowledge item database 112 stores the sensor data and metadata as knowledge items. Scenario engine 122 applies rules defined by scenarios 110 to the knowledge items to achieve sensor fusion. For example, scenario engine 122 may compare sensor data and its context against a defined set of policies and/or rules and provide some action when a rule or action is satisfied.

Message database 114 stores messages to be delivered to individuals or other knowledge switches when a scenario is triggered. Profiles manager 120 stores contact profiles to determine how a message is to be delivered to a recipient. If the contact profile does not require contact, then the message is placed into a construct referred to as a topic for later retrieval by the recipient via microbroadcasting portal 118. If the contact profile requires contact, the message is placed in a topic and a request is placed to delivery engine 116 to connect to recipient with his or her personal microbroadcast via a specified device and/or based on specified schedule. Delivery engine 116 is responsible for delivery of messages to recipients using information specified in their contact profiles and for interfacing with specific delivery devices via device-specific plug-ins 108.

Message engine 113 receives notifications from triggered scenarios and organizes them appropriately. Messages are then associated with a topic via a topic template and a contact profile for the intended recipient. The topic template may specify how a message should be presented. The contact profile may specify unique user preferences for delivering the message.

As stated above, content manager 111 merges data from different sensors with metadata identifying the source of the data using source plug-ins 104. The metadata that can be linked to the sensor data may include information about where a specific sensor is known to reside (geographical location, building, facility room, or other positional information), links back to knowledge item database 112 to other data that is known to be relevant to the context of the sensor data (links to historical data readings, links to data from other sensors in the same general region), current time and date information, context about the type of sensor collecting the data (such as thermostat, range of acceptable data readings, known standard limits), links to history data (when installed, offline times, repair records) and links to any previous points in history when this data was involved in triggering of a scenario.

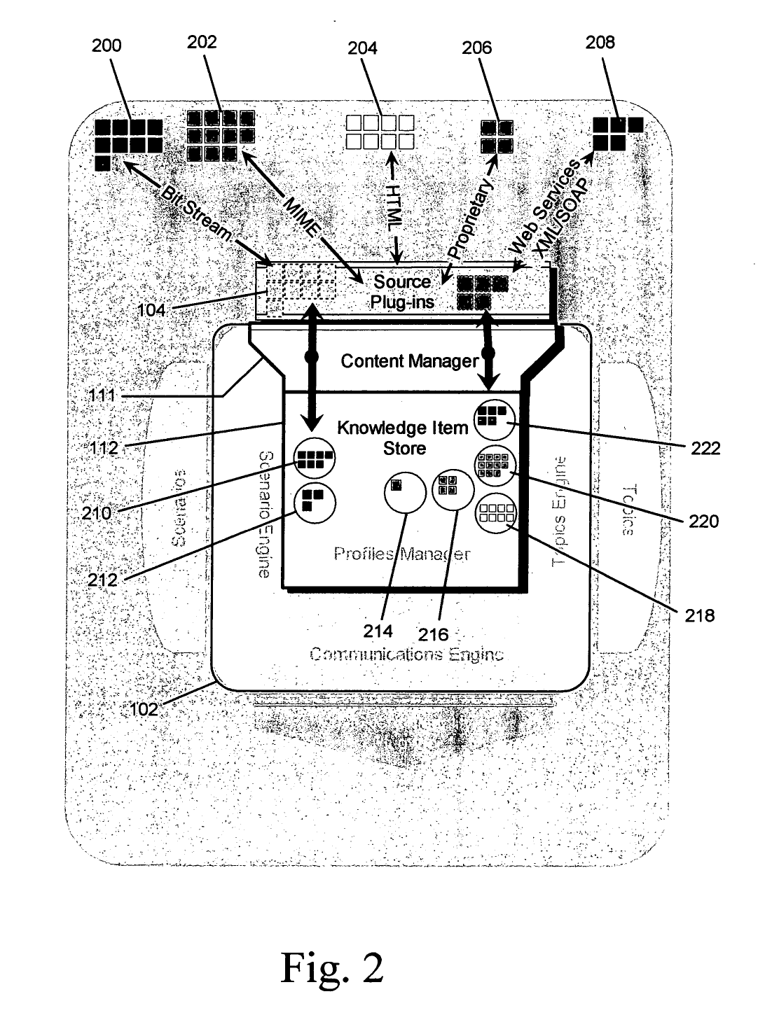

FIG. 2 is a block diagram illustrating exemplary operation of source plug-ins 104, content manager 111, and knowledge item database 112 in more detail. In FIG. 2, source plug-ins 104 receive data from a plurality of different sensors 200-208. The data arrives in different formats, such as bit stream format, mime format, HTML format, proprietary format, or web formats, such as XML or SOAP. Source plug-ins 104 receive the data in different formats and provide the data to content manager 111. Content manager 111 associates the data from the various sensors with context-specific metadata and stores the data in knowledge item database 112. The data is stored as knowledge items 210-222, which include the sensor data and the context-specific metadata.

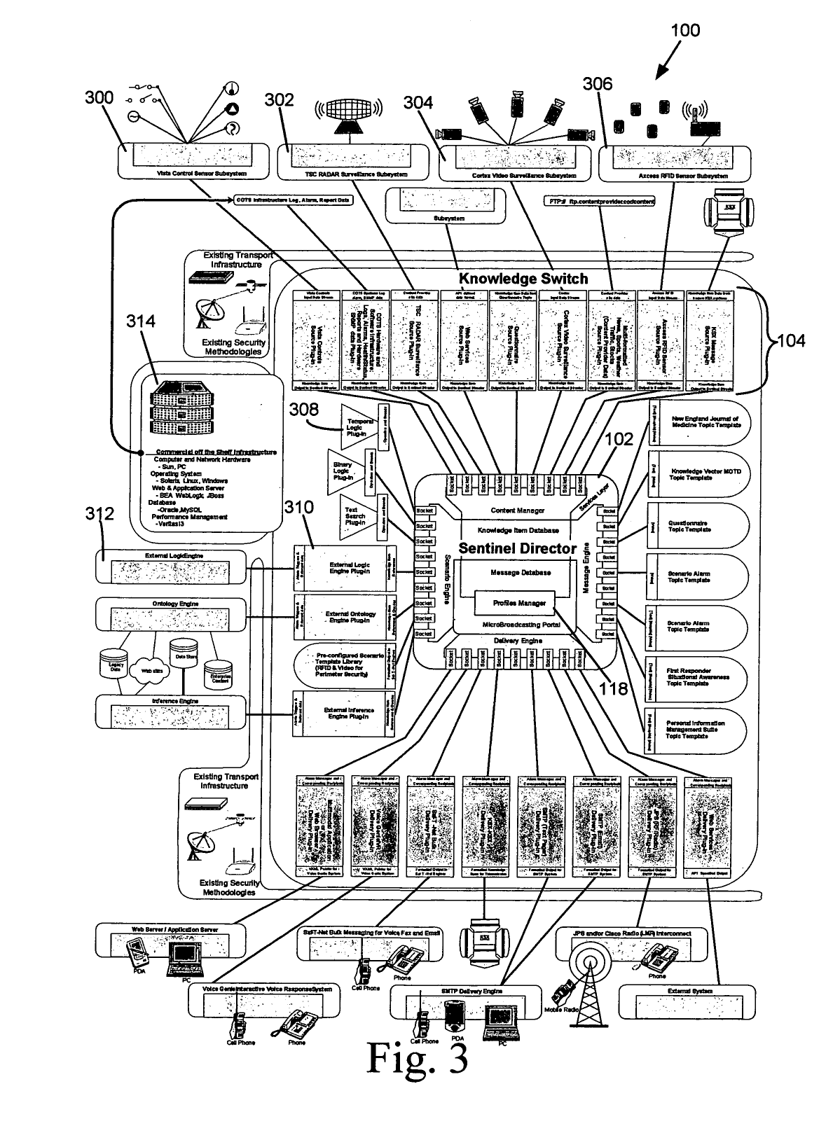

FIG. 3 is a block diagram illustrating an exemplary deployment of knowledge switch 100 illustrated in FIG. 1. In FIG. 3, knowledge switch 100 includes source plug-ins 104 to interface with different types of sensors 300-306. Knowledge switch 100 may further include rules plug-ins 308 and 310 to interface with external logic engines 312. External logic engines 312 may be logic engines that are associated with agencies that process data using their own internal rules. For example, external logic engines 312 may be logic engines provided by federal or local law enforcement agencies that process data to identify the presence of an event that requires an alert to be generated. Once a rule or policy is satisfied, an associated rule takes data objects involved at that point when the rule was satisfied and determines who to transfer the information to by the use of profiles stored by profiles manager 118. The profile may include contact information generated when the recipient's profile was created and may be maintained by the recipient or a representative of the recipient. The profile determines what information should be received by the recipient, the format of the information based on the list of devices provided by the recipient, or any organizational information that defines the type of information that the recipient is allowed to receive.

The distribution of information may further be qualified by dynamic groups, asynchronous routing, and authentication and acknowledgement methods. For example, a dynamic group may be defined by a profile maintained by profiles manager 120. The profile for a dynamic group may contain an identifier, such as “first shift management team,” which is linked with the profiles of individuals that are current members of the management team so that alerts that are generated during the first shift will be distributed to the appropriate individuals and in the appropriate formats. Asynchronous routing refers to a routing method defined in an individual's profile where a message is first attempted to be delivered to the individual. Delivery may be reattempted for a time period defined in the individual's profile. If delivery fails within the time period, delivery may be attempted to a fallback individual defined within the first individual's profile. Authenticated delivery refers to the requiring an individual to provide credentials as a condition to receiving a message. Confirmed delivery refers to requiring the recipient to confirm receipt of a message by providing an acknowledgement when a message is received an understood. These aspects of information delivery may be controlled by delivery engine 116 under the control of profiles provided by profiles manager 118.

The system illustrated in FIGS. 1-3 is preferably extensible through the use of modular plug-ins. An example of a modular sensor plug-in using an API written using the API provided by core 102 is as follows:

Example of a Sensor Plug-in:

“Foo Bar” company provides a weather station aggregator sensor system, which periodically reports temperature, humidity, and wind speed recorded by a number of remote devices. Using an API provided by the developer of knowledge switch 100, the plug-in developer:
1. Creates an XML content type definition using a sensor content-type data schema to describe the data structure for the weather sensor's reports including field names and data types (Double: temperature, Double: humidity, Double: windSpeed, String: remoteDeviceId). Since all “Foo Bar” weather station remote devices report using the same data structure, there is no need in this case to define multiple content types. If more than one data structure were being reported, the developer would simply create any additional content type definitions needed and then add any necessary custom handler code to the plug-in, if such were required in order for the plug-in to distinguish between types of incoming reports from the external sensor system.
2. Optionally creates an XML sensor instance definition using a sensor instance schema provided by the developer of knowledge switch 100. Instance definitions describe existing individual sensor devices (in this case, the actual device endpoints) and can prove useful when writing scenario rules (e.g.: for setting up filters based on known sensors) or when including specific sensor data in KSX-generated messages.
3. Extends the base sensor class to provide the runtime functionality of the plug-in, overriding the default runtime methods (such as init, startup, shutdown, etc) with “Foo Bar” sensor-specific implementations. In this case, the startup method is overridden to initially connect via network socket to the weather station aggregator and register to receive its data reports. The developer may also include custom exception handlers for dealing with the case of a connection or registration error (e.g.: some developers might choose to implement a sleep/retry scheme to re-attempt a connection, while other may prefer to simply log the error and terminate). Similarly, the shutdown method is overridden to send an un-register message to the weather station aggregator (so that the aggregator does not keep attempting to send reports) and then closes the reporting socket. The plug-in API includes documented methods for reporting and persisting new incoming data from the plug-in to the KSX, and the developer simply invokes these methods in order to have the KSX scenario engine process incoming data from the plug-in.
4. Packages the plug-in into a standard jar file, configures the plug-in's descriptor (with information such as auto-start plug-in on startup of KSX), and places the jar into the plug-ins directory of a KSX. If the plug-in is set up to auto-start on KSX startup, the plug-in would automatically start upon the next restart of the KSX; alternately, the KSX administrator may dynamically re-initialize, start, or stop the plug-in during KSX run-time, via a KSX plug-in management console.

Similar plug-ins may be provided for extending the functionality scenario engine 122, delivery engine 116, and message engine 118 illustrated in FIG. 1.

Providing a core set of modules that is sensible through plug-ins allow the size of the system to be kept to an potable minimum while enabling full functionality for real world deployments. As new sensors are brought on line and old sensors are taken off line, the plug-in layer can be added to or removed from as needed to keep the deployment from becoming top heavy and having to maintain processing logic for hundreds or even thousands of sensors which do not figure in to a particular deployment. More importantly, the flexibility derived from the plug-in layer and the ability to abstract sensors into a real world deployment over time allows newly created sensors that did not exist at the time the system was conceived to be able to be added with real time addition of a new plug-in that is associated with a sensor.

The system illustrated in FIGS. 1-3 can run on general-purpose computing platforms, as illustrated by reference numeral 314 illustrated in FIG. 3. General-purpose computing platforms 314 may be single- or multi-processor systems that are capable of executing computer instructions. The number of processors and associated memory may depend on the number of plug-ins associated with a particular deployment.

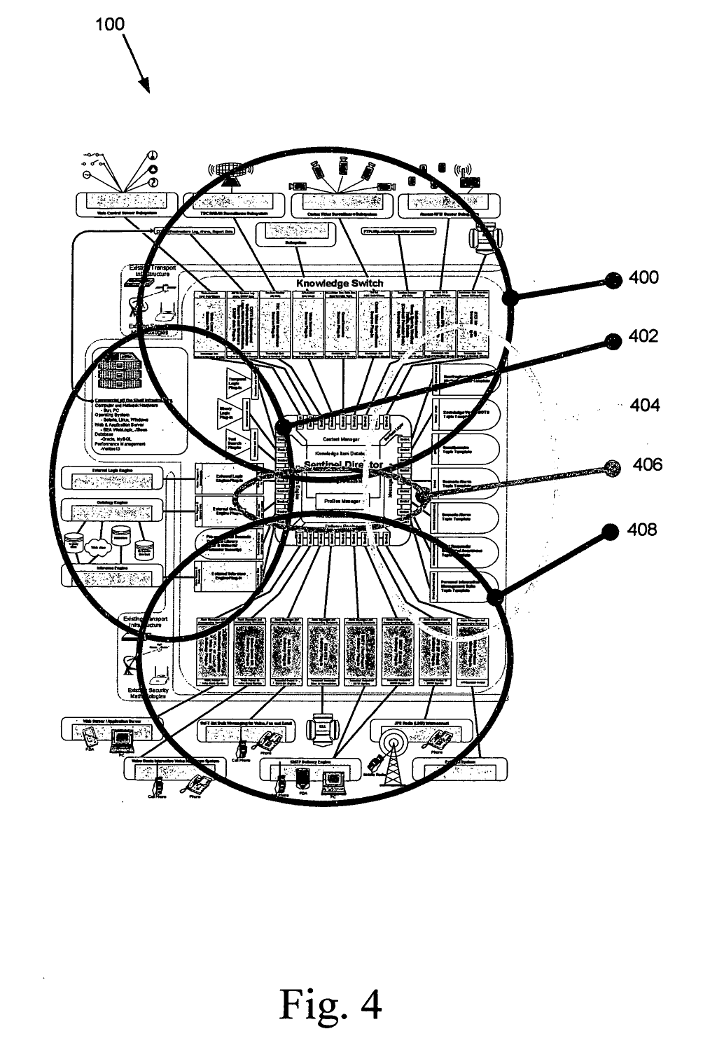

FIG. 4 is a block diagram of the knowledge switch illustrated in FIG. 3 highlighting the areas of system 100 responsible for the different aspects of processing data from various sensors. More particularly, the components within area 400 include sensors, sensor plug-ins, the content manager, and the knowledge item database where sensor data is stored along with its relevant context information as metadata. Area 402 represents internal and external rules that are applied to the sensor data and its metadata to generate actions, such as contacting relevant individuals when a rule or policy has been satisfied. Area 404 represents the creation and issuance of context rich messages when the rules and/or policies are satisfied. Area 406 includes the components responsible for profiled-based, specific delivery of the message to different recipients. Area 408 represents the components responsible for delivery of the messages to the recipients over various communications media.

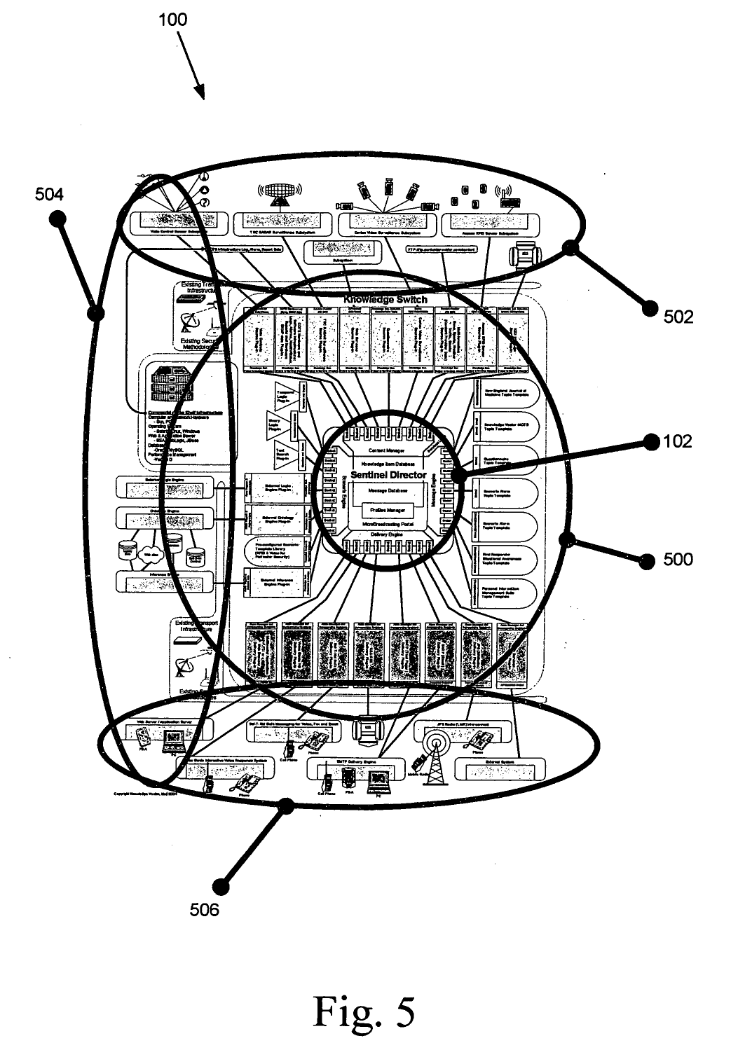

FIG. 5 is a block diagram of the system illustrated in FIG. 3 illustrating additional areas of system 100 and the associated devices with which it interfaces. More particularly, the system includes core 102 that includes the components that are deployed with each deployment of system 100. These components are described above with regard to FIG. 3. Hence, a description thereof will not be repeated herein. Area 500 includes core 102 plus the plug-ins that are responsible for the optimizing core 102 for a particular deployment. The components within areas 502, 504, and 506 represent the external devices with which system 100 interfaces. In the illustrated example, these devices include sensors, external rule and logic systems, communications channels in their associated devices and protocols.

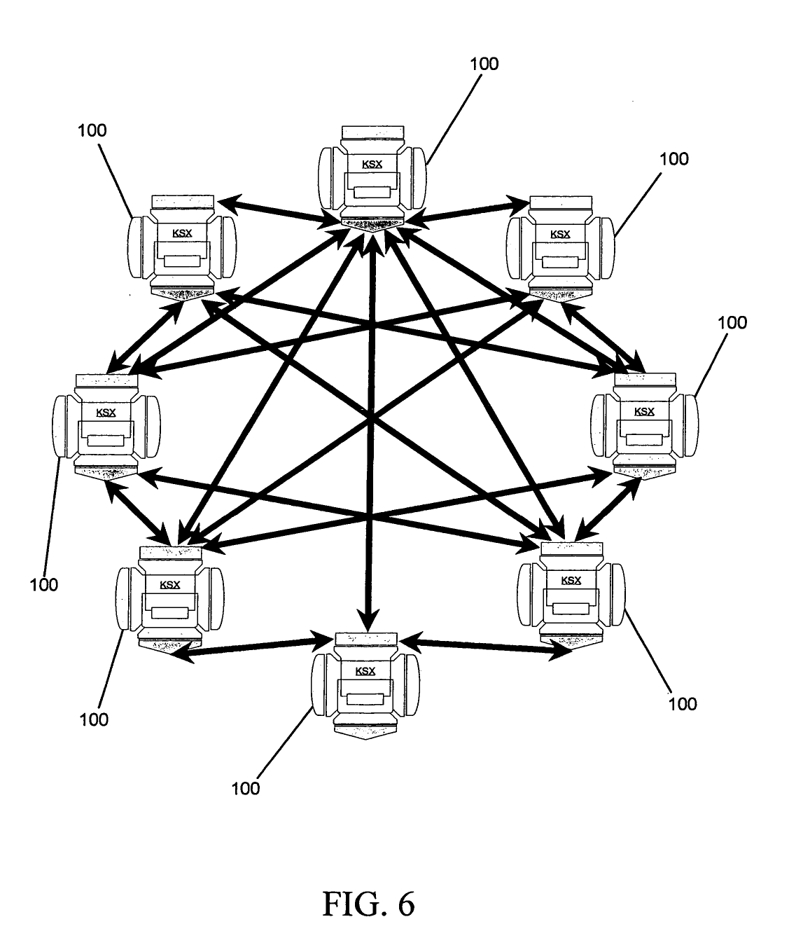

FIG. 6 is a block diagram illustrating one deployment of a plurality of knowledge switches 100 that communicate with each other in a peer-to-peer manner. In FIG. 6, eight switches 100 are illustrated. Each switch 100 preferably has the ability to communicate with every other switch in the distribution. A traditional publish and subscribe communications protocol can be used to ensure that as one switch 100 has a rule that is satisfied, a corresponding knowledge item will be distributed to the full group. Any other switch 100 in the group that is subscribed to receive such information will receive the information immediately upon the information being transmitted by the originating system. Such a deployment will be optimal for a university system or a large international corporation with offices distributed in geographically separate locations.

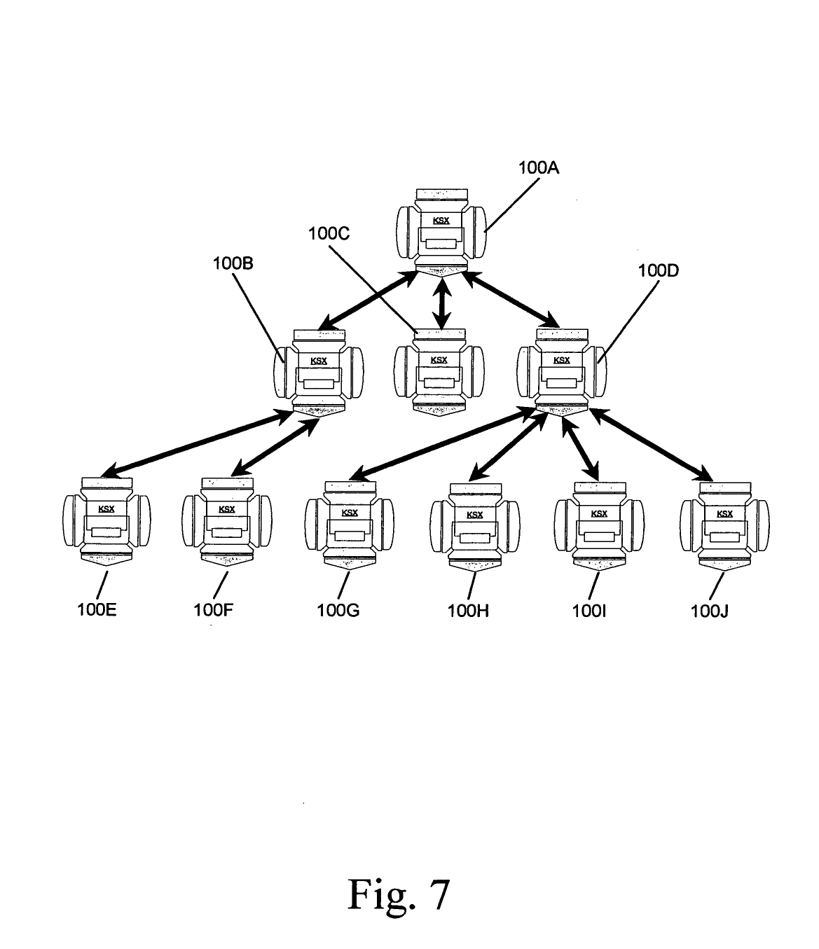

FIG. 7 illustrates a hierarchical deployment of knowledge switches 100A-J according to embodiment of the subject matter described herein. In FIG. 7, communications between knowledge switches are no longer flat, but rather travel up and down a predetermined chain of command. A top node knowledge switch 100A may have the responsibility of passing requests down through the chain and also have receiving information only form links to knowledge switches 100B, 100C, and 100D on the next level in hierarchy. The knowledge switches in the next level may only receive information from knowledge switches 100E-100J on the next level of the hierarchy. Typically this type of deployment would be used in agencies or within a corporation where there is too much event information for a single system to process. As a result, the load is distributed among nodes 100E-100J and processed by rules of increasing discrimination at higher levels in the hierarchy. The hierarchical deployment of knowledge switches also allows for the provisioning of lower tier systems automatically with the subsets of the top tiers systems, the rule sets, recipient profiles, and distribution profiles. Hierarchical provisioning allows an upper tier knowledge switch 100A to load balance various activities (sensor data collection for example) by automatically provisioning lower tier knowledge switches 100B-100J with rules subsets which if satisfied act as a single sensor data event to an upper tier system. Such hierarchical provisioning dramatically lightens the processing overhead. The in same way, redundancy of systems and rules can be instituted.

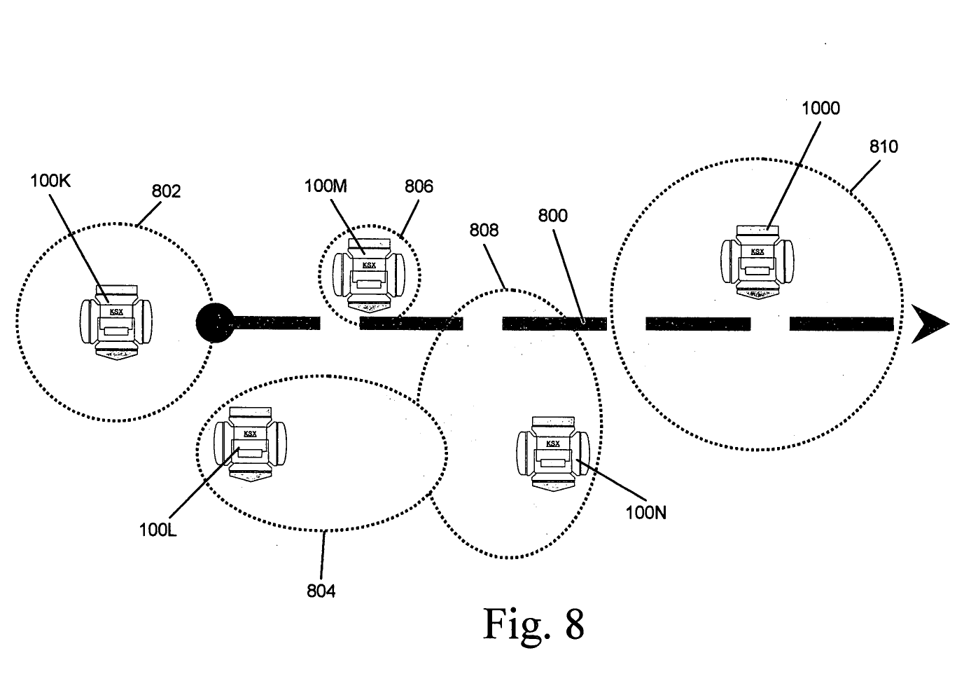

FIG. 8 is a block diagram illustrating a deployment of knowledge switches 100K-100O where some of the knowledge switches are located on mobile platforms and other knowledge switches are located on stationary platforms. For example, knowledge switch 100K may be located on a mobile platform such as a car, a train, an aircraft, or a watercraft. Knowledge switch 100K maintains the responsibility for sensors and events based on the scope of an area of awareness for that system. In this instance, the area of awareness may be defined as the geographical functional boundaries that describe the limit of the sensors that are associated with the particular system. For any one system, there can be multiple areas of awareness depending on the sensor events being accessed by the rules in question. The remaining knowledge switches illustrated in FIG. 8 may be associated with stationary platforms or other mobile platforms. For example, if knowledge switch 100K is located on a watercraft, such as barge, knowledge switch 100L may be located on a bridge. Knowledge switches 100K and 100L may be communication with each other when knowledge switch 100K comes with in the area of awareness of knowledge switch 100L. Knowledge switch 100K may communicate cargo being carried into the area of awareness of knowledge switch 100L. Knowledge switch 100L may indicate whether or not it is safe to bring the specific cargo into its area of awareness given circumstances regarding the bridge. For example, it may not be safe to bring a cargo of explosive material through the main channel under the bridge during a time of heavy traffic on the bridge.

As described above, in peer-to-peer deployments, communications may be initiated through publish and subscribe methodologies. In hierarchical deployments, communications between knowledge switches may be initiated by higher nodes querying lower nodes or lower nodes transmitting accumulated data from satisfied rules to higher nodes. Within systems deployed using an area of awareness, communications between systems may be initiated by the geographical functional boundaries from separate systems overlapping or triggering a conversation between systems to determine if and what information needs to be exchanged. This is a hybrid of the two previous systems in that a triggering event initiates the initial communications. In instance of a railway, a train may have a knowledge switch located on board that is traveling through a specified path, such as path 800. Along the journey, the geographic areas of awareness boundaries 804, 806, 808, and 810 may intersect or not intersect with area of awareness boundary 802 of knowledge switch 100K. When intersection occurs, the stationary systems may communicate with mobile system 100K. These stationary systems may represent car reporting stations or track repair warnings located at stations. The stations may also represent other transit systems, like another train that could relay operating conditions weather, notices, and other relevant information regarding where they have been and where they are traveling.

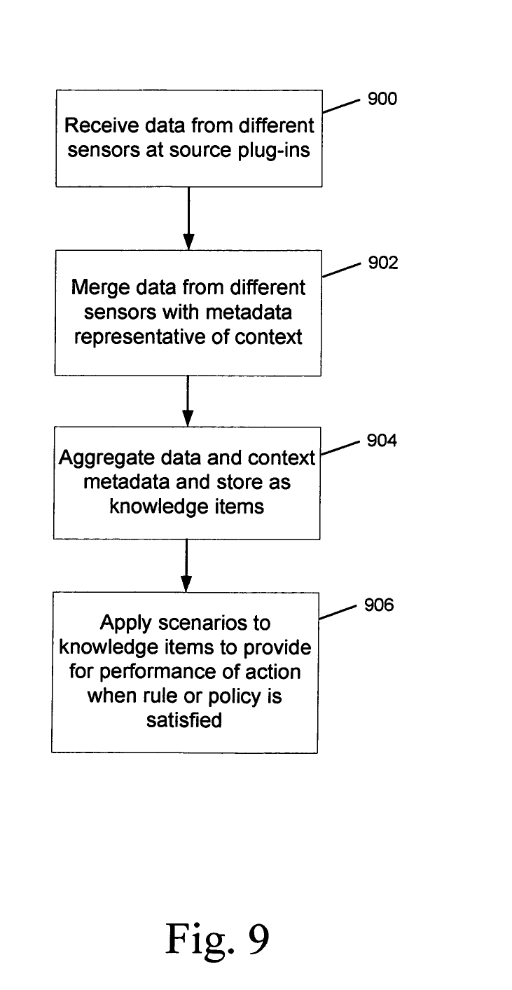

FIG. 9 is a flow chart illustrating exemplary overall steps that may be implemented by a knowledge switch in merging data from different sensors and for achieving sensor fusion according to an embodiment of the subject matter described herein. Referring to FIG. 9, in step 900, data is received at a plurality of source plug-ins from a plurality of different sensors. For example, in a knowledge switch system deployed at an airport, data may be received from a motion sensor monitoring motion along a specific section of an airport perimeter fence and from a camera recording image data for the same section of fence. In step 902, the data from the sensors is merged together with metadata that is representative of a context. For example, the data from the motion sensor may be paired with context indicating that motion was detected the time of the motion, the location of the motion, and the sensor ID. The data from the camera may be paired with context data indicating the time an image was recorded, the recording location, and the camera ID. In step 904, the data and the context metadata are aggregated and stored as knowledge items. This step may include packaging the motion sensor and image data in knowledge item data structures linked or including the above-described metadata. In step 906, scenarios are applied to the knowledge items to provide for performance of an action when a rule or policy defined by the scenarios is satisfied. For example, a scenario may be defined with the following rules:

IF MOTION.DETECTED==TRUE
{
SEARCH KNOWLEDGE ITEM DATABASE FOR CAMERA
KNOWLEDGE ITEM WITH:
RECORDING.TIME==MOTION.TIME&&RECORDING.
LOCATION==MOTION.LOCATION;
IF (RECORD_LOCATED) THEN SEND(CAMERA.IMAGE,
RECORDING.LOCATION, RECORDING.TIME, CONTACT_LIST);
}

In the pseudo-code scenario example above, the code determines whether the motion.detected field in a motion sensor knowledge item is true. If this field indicates that motion was detected, the content manager searches the knowledge item database for a camera knowledge item for the same location and time where the motion was detected. The content manager then calls a send function that invokes the delivery engine to send the camera image, the recording location, and the recording time to members of a contact list. Thus, using knowledge items and the exemplary scenario above, data from different sensors is merged with context metadata, the context metadata is used to locate and compare the data from the different sensors, and the data and the context metadata are communicated to an appropriate set of recipients when a rule is satisfied.

### Functional Libraries

As stated above, the present subject matter may include a library of mathematical and other functional expressions usable to define logic implemented by knowledge switch 100. More particularly, this library may be available to scenario programmers to define scenarios usable by scenario engine 116 to operate on knowledge items stored in database 112 and perform or provide for performance of an action in response to a rule or policy being satisfied. The follow are examples of functional expressions that may be included in such a library:

TABLE 1
Mathematical Functions Usable in Scenarios

| | | Short | | Argument | Full |
|---|---|---|---|---|---|
| Name | Category | Description | Arguments | Description | Description |
| Abs | Math & Trig | Returns the | number | Number is | Returns the |
| | | absolute | | the number | absolute value |
| | | value of a | | of which you | of a number. |
| | | number | | want the | The absolute |
| | | | | absolute | value of a |
| | | | | value. | number is the |
| | | | | | number without |
| | | | | | its sign. |
| Acos | Math & Trig | Returns the | number | Number is | Returns the |
| | | arccosine, or | | the cosine of | arccosine, or |
| | | inverse | | the angle | inverse cosine, |
| | | cosine, of a | | you want and | of a number. |
| | | number | | must be from | The arccosine |
| | | | | −1 to 1. | is the angle |
| | | | | | whose cosine is |
| | | | | | number. The |
| | | | | | returned angle |
| | | | | | is given in |
| | | | | | radians in the |
| | | | | | range 0 (zero) |
| | | | | | to pi. |
| Acosh | Math & Trig | Returns the | number | Number is | Returns the |
| | | inverse | | any real | inverse |
| | | hyperbolic | | number | hyperbolic |
| | | cosine of a | | equal to or | cosine of a |
| | | number. | | greater than | number. |
| | | | | 1. | Number must |
| | | | | | be greater than |
| | | | | | or equal to 1. |
| | | | | | The inverse |
| | | | | | hyperbolic |
| | | | | | cosine is the |
| | | | | | value whose |
| | | | | | hyperbolic |
| | | | | | cosine is |
| | | | | | number, so |
| | | | | | ACOSH(COSH |
| | | | | | (number)) |
| | | | | | equals number. |
| Asin | Math & Trig | Returns the | number | Number is | Returns the |
| | | arcsine, or | | the sine of | arcsine, or |
| | | inverse sine, | | the angle | inverse sine, of |
| | | of a number. | | you want and | a number. The |
| | | | | must be from | arcsine is the |
| | | | | −1 to 1. | angle whose |
| | | | | | sine is number. |
| | | | | | The returned |
| | | | | | angle is given |
| | | | | | in radians in |
| | | | | | the range −pi/2 |
| | | | | | to pi/2. |
| Asinh | Math & Trig | Returns the | number | Number is | Returns the |
| | | inverse | | any real | inverse |
| | | hyperbolic | | number. | hyperbolic sine |
| | | sine of a | | | of a number. |
| | | number | | | The inverse |
| | | | | | hyperbolic sine |
| | | | | | is the value |
| | | | | | whose |
| | | | | | hyperbolic sine |
| | | | | | is number, so |
| | | | | | ASINH(SINH(number)) |
| | | | | | equals |
| | | | | | number. |
| Atan | Math & Trig | Returns the | number | Number is | Returns the |
| | | arctangent, | | the tangent | arctangent, or |
| | | or inverse | | of the angle | inverse |
| | | tangent, of a | | you want | tangent, of a |
| | | number. | | | number. The |
| | | | | | arctangent is |
| | | | | | the angle |
| | | | | | whose tangent |
| | | | | | is number. The |
| | | | | | returned angle |
| | | | | | is given in |
| | | | | | radians in the |
| | | | | | range −pi/2 to |
| | | | | | pi/2. |
| Atanh | Math & Trig | Returns the | number | Number is | Returns the |
| | | inverse | | any real | inverse |
| | | hyperbolic | | number | hyperbolic |
| | | tangent of a | | between 1 | tangent of a |
| | | number. | | and −1. | number. |
| | | | | | Number must |
| | | | | | be between −1 |
| | | | | | and 1 |
| | | | | | (excluding −1 |
| | | | | | and 1). The |
| | | | | | inverse |
| | | | | | hyperbolic |
| | | | | | tangent is the |
| | | | | | value whose |
| | | | | | hyperbolic |
| | | | | | tangent is |
| | | | | | number, so |
| | | | | | ATANH(TANH |
| | | | | | (number)) |
| | | | | | equals number. |
| Cos | Math & Trig | Returns the | number | Number is | Returns the |
| | | cosine of a | | the angle in | cosine of the |
| | | number. | | radians for | number. |
| | | | | which you | |
| | | | | want the | |
| | | | | cosine. | |
| Cosh | Math & Trig | Returns the | number | Number is | Returns the |
| | | hyperbolic | | any real | hyperbolic |
| | | cosine of a | | number for | cosine of a |
| | | number. | | which you | number. |
| | | | | want to find | |
| | | | | the | |
| | | | | hyperbolic | |
| | | | | cosine. | |
| Exp | Math & Trig | Returns e | number | Number is | Returns e |
| | | raised to the | | the exponent | raised to the |
| | | power of | | applied to | power of |
| | | number. | | the base e. | number. The |
| | | | | | constant e |
| | | | | | equals |
| | | | | | 2.71828182845904, |
| | | | | | the base |
| | | | | | of the natural |
| | | | | | logarithm. To |
| | | | | | calculate |
| | | | | | powers of other |
| | | | | | bases, use the |
| | | | | | exponentiation |
| | | | | | operator (\hat{ }). |
| | | | | | EXP is the |
| | | | | | inverse of LN, |
| | | | | | the natural |
| | | | | | logarithm of |
| | | | | | number. |
| Ln | Math & Trig | Returns the | number | Number is | Returns the |
| | | natural | | the positive | natural |
| | | logarithm of | | real number | logarithm of a |
| | | a number. | | for which you | number. |
| | | | | want the | Natural |
| | | | | natural | logarithms are |
| | | | | logarithm. | based on the |
| | | | | | constant e |
| | | | | | (2.71828182845904). |
| | | | | | LN is |
| | | | | | the inverse of |
| | | | | | the EXP |
| | | | | | function. |
| Log | Math & Trig | Returns the | number, | Number is | Returns the |
| | | logarithm of | base | the positive | logarithm of a |
| | | a number to | | real number | number to the |
| | | the base you | | for which you | base you |
| | | specify | | want the | specify |
| | | | | logarithm. | |
| Mod | Math & Trig | Returns the | number, | number is | Returns the |
| | | remainder | divisor | the number | remainder after |
| | | after integer | | of which you | integer division |
| | | division | | want to | |
| | | | | obtain the | |
| | | | | remainder | |
| Rand | Math & Trig | Returns an | | | Returns an |
| | | evenly | | | evenly |
| | | distributed | | | distributed |
| | | random real | | | random real |
| | | number | | | number greater |
| | | greater than | | | than or equal to |
| | | or equal to 0 | | | 0 and less than |
| | | and less | | | 1. To generate |
| | | than 1. | | | a random |
| | | | | | number |
| | | | | | between a and |
| | | | | | b, use: |
| | | | | | rand( ) * (b − a) + a |
| Sinh | Math & Trig | Returns | angle | | Returns |
| | | hyperbolic | | | hyperbolic sine |
| | | sine of a an | | | of an angle |
| | | angle | | | |
| Sqrt | Math & Trig | Returns the | number | | Returns square |
| | | square root | | | root of a |
| | | of a number | | | number |
| Sum | Math & Trig | sum the list | number*, ... | number is a | sums the list of |
| | | of args | | list of | arguments |
| | | | | expressions | |
| Tan | Math & Trig | Returns | angle | | Returns |
| | | tangent of | | | tangent of an |
| | | an angle | | | angle |
| Tanh | Math & Trig | Returns | angle | | Returns |
| | | hyperbolic | | | hyperbolic |
| | | tangent of | | | tangent of an |
| | | an angle | | | angle |
| If | Logical | Returns the | Boolean | | |
| | | Boolean | expression | | |
| | | value of an | | | |
| | | expression | | | |
| Sumif | Event | Returns a | conditional | | Returns a |
| | | conditionally | expression, | | conditionally |
| | | accumulated | sum | | accumulated |
| | | sum of an | expression | | sum of an |
| | | expression. | | | expression. If |
| | | | | | the conditional |
| | | | | | expression is |
| | | | | | true, then the |
| | | | | | sum expression |
| | | | | | is calculated |
| | | | | | and added to a |
| | | | | | running |
| | | | | | accumulation of |
| | | | | | the function |
| | | | | | over its lifetime. |
| anynwithin | Event | Returns true | time, n, | Time - is the | Returns true if |
| | | if at least “n” | Boolean | lifetime | at least “n” of |
| | | of the | expression, * | window in | the Boolean |
| | | Boolean | | milliseconds | expressions are |
| | | expressions | | for each | true. This |
| | | are true. | | variable in | function never |
| | | | | the | returns false. If |
| | | | | expressions. | the minimum |
| | | | | n - is the | number of |
| | | | | minimum | expressions are |
| | | | | number of | not true, then |
| | | | | Boolean | this function |
| | | | | expressions | returns NaN |
| | | | | which must | |
| | | | | be true. | |
| | | | | Expression* - | |
| | | | | is a list of | |
| | | | | Boolean | |
| | | | | expressions | |
| | | | | separated by | |
| | | | | commas. | |
| Within | Event | Returns true | time, | Time - is the | Returns true if |
| | | if expression | expressionA, | lifetime | expression B |
| | | B becomes | expressionB | window in | becomes true |
| | | true after | | milliseconds | within the time |
| | | and within | | for each | window after |
| | | time window | | variable in | ExpressionA |
| | | of event A. | | the | becomes true. |
| | | | | expressions. | This function |
| | | | | ExpressionA - | returns NaN |
| | | | | the first | when a variable |
| | | | | expression | in expressionA |
| | | | | ExpressionB - | is updated and |
| | | | | the | ExpressionA is |
| | | | | dependent | true or false |
| | | | | expression | and Expression |
| | | | | which must | B is false. This |
| | | | | become true | function returns |
| | | | | after | false when A |
| | | | | ExpressionA | evaluates to |
| | | | | | true and the |
| | | | | | time window |
| | | | | | specified by |
| | | | | | “time” has |
| | | | | | passed before |
| | | | | | ExpressionB |
| | | | | | becomes true. |
| | | | | | This function |
| | | | | | only returns |
| | | | | | true if |
| | | | | | ExpressionA |
| | | | | | and Expression |
| | | | | | B are true. |
| Holdfirst | Event | Returns NaN | expression | expression - | Returns NaN |
| | | until the first | | is a Boolean | until the first |
| | | evaluation | | expression | evaluation that |
| | | that results | | | results in true |
| | | in true and | | | and thereafter |
| | | thereafter | | | returns true. |
| | | returns true. | | | Once the |
| | | | | | function |
| | | | | | evaluates to |
| | | | | | true, variables |
| | | | | | are no longer |
| | | | | | updated. |
| Holdlast | Event | Returns NaN | expression | expression - | Returns NaN |
| | | until the first | | is a Boolean | until the first |
| | | evaluation | | expression | evaluation that |
| | | that results | | | results in true |
| | | in true and | | | and thereafter |
| | | thereafter | | | returns true. |
| | | returns true. | | | Variables which |
| | | | | | continue to |
| | | | | | resolve the |
| | | | | | expression to |
| | | | | | true are |
| | | | | | updated. |
| Minutes | Event | Returns the | number | number - is | Returns the |
| | | number of | | the number | number of |
| | | milliseconds | | of minutes | milliseconds |
| | | represented | | | represented by |
| | | by the | | | the specified |
| | | specified | | | number of |
| | | number of | | | minutes |
| | | minutes | | | |
| Seconds | Event | Returns the | number | number - is | Returns the |
| | | number of | | the number | number of |
| | | milliseconds | | of seconds | milliseconds |
| | | represented | | | represented by |
| | | by the | | | the specified |
| | | specified | | | number of |
| | | number of | | | seconds |
| | | seconds | | | |
| Near | Spatial | Returns true | point1, | point1 is the | Returns true if |
| | | if two points | point2, | latlon for the | two points are |
| | | are within a | span | first point | within a |
| | | minimum | | point2 is the | minimum |
| | | distance of | | latlon for the | distance of |
| | | each other | | second point | each other |
| | | | | span is the | |
| | | | | maximum | |
| | | | | distance | |
| | | | | between the | |
| | | | | two points | |
| Distance | Spatial | Returns the | point1, | point1 is the | Returns the |
| | | distance | point2 | latlon for the | distance |
| | | between two | | first point | between two |
| | | points | | point2 is the | points |
| | | | | latlon for the | |
| | | | | second point | |
| Search | String | Returns the | searchString, | searchString - | Returns the |
| | | position of a | keyString | look in this | position of a |
| | | string within | | string for | string within |
| | | another | | keyString - | another string. |
| | | string | | the string to | The offset is 0 |
| | | | | look for | based. If the |
| | | | | | keystring is not |
| | | | | | found then this |
| | | | | | function returns |
| | | | | | −1 |
| Len | String | Returns the | | | Returns the |
| | | length of a | | | length of a |
| | | string | | | string |
| Replace | String | Returns an | sourceString, | | Returns an |
| | | altered | matchString, | | altered source |
| | | source | replaceString | | String after |
| | | String after | | | making |
| | | making | | | matches and |
| | | matches and | | | replacing with |
| | | replacing | | | new string |
| | | with new | | | |
| | | string | | | |
| substring | | Returns a | sourceString, | | Returns a |
| | | portion of a | startoffset, | | portion of a |
| | | string | length | | string |

Exemplary Scenario

The following is an example of a scenario that is written using the anynwithin( ) function illustrated in Table 1. The anynwithin( ) function determines if any number of events occur within a specific timeframe, and if any events occur, the expression is declared valid.

Explanation: Trigger when a camera detects motion and a check is transacted within 5 seconds (correlates a check transaction with a video clip)

trigger = anynwithin ( seconds(5), 2,
${com.kvector.sensor.video.VideoData[NVRLocation/
KVI_Headquarters]Type} == 5,
@RECEIVED
${com.kvector.demo.checkreader[checkReaderLocation/
W_Morgan_St]checkNumber} )

In the code example above:
“Seconds(5)” is the timeframe within which the following events must occur, where it could also be Minutes(15), days(3) or years(2).
“2” is the number of sensors to be referenced as a part of the statement
The next part is a reference to a video sensor, location and the sensor state
   $(sensor-type[Sensor-Location]==Something-is-in-the-field-of-view-and-moving)
The last part is a reference to a check reader at the same location as the video camera, getting the check number from the transaction.
   A-check-transaction-is-RECEIVED-from: $(sensor-type[Sensor-Location]Data-bit-to-be-collected)
      Such a scenario may be implemented by the scenario engine illustrated, for example, in FIG. 1 to determine whether motion is detected within a predetermined time period of recording an image by a video camera.
      Refinements and Examples

The following refinements and examples are intended to be within the scope of the subject matter described herein. For example, a knowledge switch may include one or more of the following capabilities:
(1) The ability to receive the output from a plurality of different sensors
(2) The ability to merge the data from individual sensors together with metadata that is representative of a real world context
(3) The ability to achieve sensor fusion by comparing the sensor data and its context against a defined set of policies and/or rules and providing some action when the rule or policy is satisfied
(4) The ability to aggregate the information and context metadata from the sensor fusion into a knowledge item
(5) The ability to transmit the knowledge item together with additional predetermined messages across a multiplicity of telecommunications channels to a multiplicity of recipients
(6) The ability to transmit the same knowledge items to humans, other knowledge switches, and computer systems utilizing only profile information as the differentiator for formatting
(7) The ability to automatically transmit the knowledge item utilizing dynamic profile information
(8) The ability to facilitate a broad range of secure and authenticated transmission of knowledge items
(9) The ability to facilitate non-linear, authenticated transmission of knowledge items
(10) The ability to automatically transmit the knowledge item to an appropriate fallback recipient if the initial target proves to be unavailable
(11) The ability to dynamically define and utilize a specific subset of an overall group, based on rules or policy definitions
(12) The ability to utilize temporal, mathematical, and external logic libraries to create rules and policy for the system
(13) The ability to create a distributed group of systems where the rules and policies for each node are dictated by the layout and hierarchy of the distribution
(14) The ability to extend each aspect of the system, in real-time, with plug-in software modules that can modify or add to existing system functionality

The sensor plug-ins that extend the capabilities of the knowledge switch may interface may receive and store the data output from a first sensor and data from a second sensor which have no relationship to one another, where a sensor is defined as (but not limited to):
(1) Any mechanical or digital instrument capable of transmitting relevant information
(2) A (sensor) sub-system that transmits pre-filtered data
(3) A stand-alone element (sensor) that transmits raw data
(4) Requested information transmitted from a human being
(5) A second (or third, or fourth . . . ) knowledge switch
(6) Internal data gathered from within the knowledge item database
(7) Profile information for potential recipients
(8) A public or private content supplier, for example a news feed or web site
(9) Email
(10) Data requested of other systems that can send data in response to a query

The content manager may provide the ability to merge the received data from the individual sensors with metadata that is representative of a real world context where the contextual metadata is (but is not limited to):
(1) Geographic location of the sensor/subsystem
(2) Time/date
(3) History (if previously encapsulated as a Knowledge Item)
(4) Rules/Policy that it has previously triggered
(5) Other associated/relevant sensor readings at the time of receipt
(6) System information (ID, version, location) from the recording knowledge switch

The scenario engine may provide the capability to define rules and policy definitions for sensor fusion by:
(1) Comparing one or more of the sensor data (as defined above) with one or more additional types of sensor data (as defined above)
(2) Comparing one or more of the sensor data (as defined above) with static values
(3) Comparing one or more of the sensor data (as defined above) with one or more of the contextual metadata (as defined above)
(4) Comparing one or more of the contextual metadata (as defined above) with one or more additional types of contextual metadata (as defined above)
(5) Comparing one or more of the contextual metadata (as defined above) with static values
(6) Utilizing function libraries to manipulate or calculate return values, based on sensor data (as defined above) or contextual metadata (as defined above)

The scenario engine may, when a policy or rule is satisfied, initiate an action where the action can be (but is not limited to):
(1) Placing a value in a specific memory location
(2) Initiating the execution of an external software application
(3) Initiating the transmission of information
(4) Posting data on a web page
(5) Initiating a query for data internally or externally
(6) Transmitting a control sequence to an external system

The content manager may generate a data object (called a knowledge item) which:
(1) Allows for the aggregation of any data type
(2) Includes composition information to allow the Knowledge Item to be decomposed to its elements
(3) Maintains a common metadata format to allow direct comparisons of any kind of data regardless of source or type
(4) Maintains history as it is passed between systems or within a system
(5) Definitions and data can be passed to other systems to allow appropriate context within a distributed network of knowledge switch systems
(6) Allows all data within system to be used as variables for rules and policy
(7) Allows for logical, hierarchical access to all encapsulated data

The delivery engine may transmit knowledge item(s) which:
(1) Are initiated when a defined rule or policy is satisfied
(2) Are included in the transmission together with additional predetermined messages
(3) Are distributed across a multiplicity of telecommunications channels
(4) Are distributed to a multiplicity of recipients
(5) Are sent to other knowledge switch with control information and policy
(6) Include text or graphic message information with the Knowledge Item per a specific recipient profile for use by that specific person/recipient
(7) Include Knowledge Item property and usage information per a specific recipient profile for use by another knowledge switch
(8) Include specific data formatting per a specific recipient profile to allow the transmission to an external computer system/application

The delivery engine may automatically transmit the knowledge item utilizing dynamic contact profile information which:
(1) Specific contact information is dependent on day/time/availability
(2) Specific information to be contained within the knowledge item vary based on location/receiving device/time of day
(3) Has second and third tier contact information in the profile if the prior fails

The dynamic contact information referred to in the preceding paragraph may include references for other profiles for other recipients to target if the initial recipient is not available. Such references may include:
(1) One or more separate fallback recipients for personal information
(2) One or more separate fallback recipients for professional information
(3) One or more separate organizationally defined/required fallback recipients

The dynamic contact information referred to above may include a default timeframe to delay before proceeding to the next contact method and/or fallback recipient such that the original recipient has time to receive the message on a non-interactive device, get to an agreed to communications device, and appropriately respond before being skipped.

The delivery engine may provide secure, authorized, and authenticated transmission of knowledge items including
(1) Authentication (Prove or confirm a users identity through some mediating technology such as PIN, password, pass-phrase, biometric, visual recognition system, trained observer)
(2) Acknowledgment (Confirmation that a message was received)
(3) Certification (Organizational request for a message receipt)
(4) Device Escalation (Progression from device to device to contact a dingle user)
(5) Personal Escalation (Personal backup recipient for delivery)
(6) Organizational Escalation (Organizational backup user or system)
(7) Contact List (List which includes all means for contacting a user)
(8) Contact Profile (Recipient organized sub-list for contacting a user)
(9) Delivery Preferences (User supplied definitions for how their Profile is utilized)
(10) Message Priority (Data tied to a message for sorting for prioritized delivery)
(11) Authorization Level (Authorization level for access rights to the content of a message)
(12) Access Profile (Authorization to access specific system resources)

The delivery engine under control of the profiles provided by the profiles manager may provide the capability to define and utilize dynamic groups, which
(1) Has a default set of members within the enclosing grouping structure
(2) Has specific and separate profile or linked criteria (either dynamic or static) for each member of the group that can be evaluated as a part of a rule or policy definition
(3) Is called by specifying the group, and a rule/policy by which to evaluate each member of the group
(4) When called, evaluates all members of the group per the rule and the individual member's criteria, and returns the specific subset of the group which satisfied the rule at the time the request was submitted
(5) Has the possibility of returning a different subset of group members every time it is called
(6) Has validity for the returned members only for the specific time at which the request is made

The scenario engine may utilize libraries of function calls as a part of the evaluation criteria for the rule/policy definitions. These function libraries may include:
(1) Temporal function libraries that incorporate actions over time as a factor of the evaluation
(2) Mathematical function libraries
(3) External logic libraries (such as inference engines within secure government labs) that can only be accessed via remote calls which include knowledge item data as a part of the function call, and which accept a return value within an expected range

The subject matter described herein may include a distributed group of knowledge switch systems where:
(1) The knowledge switch systems work in concert with one another
(2) Information is requested and/or passed between knowledge switch systems via knowledge items
(3) The rules and policies for each node can be dictated hierarchically
(4) The information can be transmitted hierarchically by directive
(5) The information transmission can be initiated as peer-to-peer requests (publish/subscribe)
(6) The information transmission can be initiated by satisfying a minimum distance for the geographic proximity between two knowledge switch systems

A knowledge switch may provide the ability to extend each aspect of the system with software modules which can be added or removed in real-time that allow the modification or addition to existing system functionality without having to restart the base application.

It will be understood that various details of the present subject matter may be changed without departing from the scope of the present subject matter. Furthermore, the foregoing description is for the purpose of illustration only, and not for the purpose of limitation.

What is claimed is:

1. A system for merging data from a plurality of different sensors and for achieving sensor fusion based on a rule or policy being satisfied, the system comprising:
(a) a plurality of source plug-ins for receiving data from a plurality of different sensors;
(b) a content manager for merging the data from the sensors together with metadata that is representative of a context and for aggregating the information and the metadata into knowledge items; and
(c) a scenario engine for achieving sensor fusion by comparing the sensor data and the metadata against a predefined set of policies or rules and for providing an action when a rule or policy is satisfied.

2. The system of claim 1 comprising a delivery engine for transmitting the knowledge items over a plurality of different communication channels in response to a rule or policy being satisfied.

3. The system of claim 2 wherein the delivery engine is adapted to transmit the knowledge items to humans, knowledge switches, and computer systems using stored profile information.

4. The system of claim 2 wherein the delivery engine is adapted to automatically transmit the knowledge items to a predetermined individual using dynamic profile information for identifying the individual.

5. The system of claim 2 where in the delivery engine is adapted to transmit the knowledge items to the recipients over secure transmission channels.

6. The system of claim 2 where in the delivery engine is adapted to transmit the knowledge items to the appropriate individuals in a nonlinear manner.

7. The system of claim 2 wherein the delivery engine is adapted to provide authenticated and confirmed transmission of the knowledge items to the recipients.

8. The system of claim 2 wherein the delivery engine is adapted to, in response to failing to deliver the knowledge items to a first recipient, to deliver the knowledge items to a fallback recipient.

9. The system of claim 2 wherein the delivery engine is adapted to deliver the knowledge items to a subset of a group of recipients based on a rule or policy definition.

10. The system of claim 1 wherein the scenario engine is adapted to interface with external mathematical and logic libraries to locate the rules and policies.

11. The system of claim 1 comprising a plurality of knowledge switches including components (a)-(c) for communicating with each other in a hierarchical or peer-to-peer manner.

12. The system of claim 1 wherein the content manager and the scenario engine are extensible in real-time via plug-in software.

13. The system of claim 1 wherein the source plug-ins are adapted to interface with sensors selected from the group consisting of mechanical sensors, electronic sensors, and electro-mechanical sensors.

14. The system of claim 1 wherein the content manager is adapted to merge the sensor data with metadata including at least one of the items selected from the group consisting of geographic location information of a sensor, time and date information, history, rule or policy that was triggered, associated sensor readings at the time of receipt, and system identification information.

15. The system of claim 1 wherein the scenario engine is adapted to compare the sensor data with one or more additional types of sensor data to determine whether one of the policies or rules is satisfied.

16. The system of claim 1 wherein the scenario engine is adapted to compare the sensor data with static values to determine whether one or more of the rules or policies is satisfied.

17. The system of claim 1 wherein the scenario engine is adapted to compare the sensor data with metadata to determine whether one or more of the policies or rules is satisfied.

18. The system of claim 1 wherein the scenario engine is adapted to compare the metadata with other metadata to determine whether one or more of the policies or rules is satisfied.

19. The system of claim 1 wherein the scenario engine is adapted to compare the metadata with one or more static values to determine whether one or more of the polices or rules is satisfied.

20. The system of claim 1 wherein the scenario engine includes a functional library including functions usable to manipulate or calculate return values based on the sensor data or the metadata.

21. The system of claim 1 wherein the scenario engine is adapted to, in response to a rule or policy being satisfied, write a value in a memory location.

22. The system of claim 1 wherein the scenario engine is adapted to, in response to one of the rules or policies being satisfied, initiate execution of an external software application.

23. The system of claim 1 wherein, in response to one of the rules or polices being satisfied, the scenario engine is adapted to initiate transmission of information.

24. The system of claim 1 wherein the scenario engine is adapted to, in response to one or more of the rule or policies being satisfied, initiate a query for internal or external data.

25. The system of claim 1 wherein the scenario engine is adapted to transmit a control sequence to an external system in response to one or more of the rules or policies being satisfied.

26. The system of claim 1 comprising first and second knowledge switches, each including elements (a)-(c) wherein the first knowledge switch is deployed on a mobile platform and the second knowledge switch is deployed on a stationary platform.

27. The system of claim 26 wherein the first and second knowledge switches each have an associated area of awareness and wherein the first and second knowledge switches are adapted to communicate with each other in response to intersection of their respective areas of awareness.

28. A method for merging data from a plurality of different sensors with context metadata and for achieving sensor fusion, the method comprising:
(a) receiving data at a plurality of source plug-ins from a plurality of different sensors;
(b) merging the data from the sensors together with metadata that is representative of a context;
(c) aggregating and storing the data and the metadata as knowledge items; and
(d) achieving sensor fusion by applying scenarios to the knowledge items and providing for performance of an action when a rule or policy defined by the scenarios is satisfied.

29. A computer program product comprising computer-executable instructions embodied in a computer-readable medium for performing steps comprising:
(a) receiving data at a plurality of source plug-ins from a plurality of different sensors;
(b) merging the data from the sensors together with metadata that is representative of a context;
(c) aggregating and storing the data and the metadata as knowledge items; and
(d) achieving sensor fusion by applying scenarios to the knowledge items and providing for performance of an action when a rule or policy defined by the scenarios is satisfied.
